(19) United States
(12) Patent Application Publication
(10) Pub. No.: US 2024/0001924 A1
(43) Pub. Date: Jan. 4, 2024

(54) COLLABORATIVE CONTROL OF VEHICLE SYSTEMS

(71) Applicant: ClearMotion, Inc., Billerica, MA (US)

(72) Inventors: Marco Giovanardi, Melrose, MA (US); Allen Chung-Hao Chen, San Jose, CA (US)

(73) Assignee: ClearMotion, Inc., Billerica, MA (US)

(21) Appl. No.: 18/037,828

(22) PCT Filed: Nov. 22, 2021
(86) PCT No.: PCT/US2021/060323

§ 371 Date: May 19, 2023

Related U.S. Application Data
(60) Provisional application No. 63/116,994, filed on Nov. 23, 2020.

(51) Int. Cl. B60W 30/18; B60W 30/02; B60W 40/072; B60W 40/068; B60W 10/18; B60W 10/20; B60W 10/22

(52) U.S. Cl. CPC B60W 30/181; B60W 30/02; B60W 40/072; B60W 40/068; B60W 10/18; B60W 10/20; B60W 10/22; B60W 2520/14

(57) ABSTRACT

A vehicle control system for a vehicle is provided. The vehicle control system may be configured to adjust a normal component of a wheel force at one or more wheels of the vehicle and steer one or more rear wheels of the vehicle to improve vehicle dynamics during a road event (e.g., braking event, steering event). The vehicle control system may generate cues to a user to provide an appropriate input based on reference road information, forward-looking road information, and/or vehicle sensor data.

### RELATED APPLICATIONS

This application claims the benefit of priority under 35 U.S.C. § 119(e) of U.S. Provisional Application Ser. No. 63/116,994, filed Nov. 23, 2020, the disclosure of which is incorporated herein by reference in its entirety.

### FIELD

Disclosed embodiments are related to collaborative control of vehicle systems, including active suspension systems, and related methods of use.

### BACKGROUND

Conventional vehicle systems traditionally operate independently from one another to achieve a desired safety outcome. For example, conventional vehicle braking systems are designed to reduce a speed of a vehicle or stop the vehicle and may be configured to include an anti-lock braking system (ABS). An ABS may control vehicle wheels to achieve a target slip in the tire at the contact point with the ground (e.g., the tire contact patch). This slip in turn creates a longitudinal force related to the normal load and the friction coefficient between the tire and the ground. Conventional braking systems operate independently from other vehicle systems such as traction control systems, steering systems, and suspension systems.

### SUMMARY

In some embodiments, a vehicle includes a first wheel, a second wheel, a rear steering system configured to apply a steering force to one or more rear wheels of the vehicle, and an active suspension system operatively coupled to the first wheel and the second wheel. The active suspension system is configured to apply active forces to the first wheel and the second wheel in at least one mode of operation to adjust a normal component of a first wheel contact force between the first wheel and a road surface and to adjust a normal component of a second wheel contact force between the second wheel and the road surface. The vehicle may also include at least one processor configured to control the rear steering system and the active suspension system, where the at least one processor is configured to determine a yaw moment of the vehicle and control the rear steering system and the active suspension system based at least partially on the yaw moment.

In some embodiments, a method of controlling a vehicle including a rear steering system and an active suspension system, where the rear steering system is configured to apply a steering force to one or more rear wheels of the vehicle, and where the active suspension system is operatively coupled to a first wheel and a second wheel, includes determining a yaw moment of the vehicle and controlling the rear steering system and the active suspension system based at least partially on the yaw moment. Controlling the active suspension system includes applying active forces to the first wheel and the second wheel to adjust a normal component of a first wheel contact force between the first wheel and a road surface and to adjust a normal component of a second wheel contact force between the second wheel and the road surface.

In some embodiments, a vehicle includes a first wheel, a second wheel, a user interface configured to allow a user to provide one or more inputs to control the vehicle, and a feedback system configured to provide feedback to the user. The vehicle also includes at least one vehicle system operatively coupled to the first wheel and the second wheel, where the at least one vehicle system is configured to apply active forces to the first wheel and the second wheel in at least one mode of operation, and at least one processor configured to control the at least one vehicle system. The at least one processor is configured to determine an appropriate input at the user interface, cue the user through the feedback to provide the appropriate input at the user interface, and control the at least one vehicle system based at least partially on the appropriate input.

In some embodiments, a method of controlling a vehicle including a user interface, a feedback system, and at least one vehicle system, where the user interface is configured to allow a user to provide one or more inputs to control the vehicle, where the feedback system is configured to provide feedback to the user, and where the at least one vehicle system is operatively coupled to a first wheel and a second wheel of the vehicle, includes determining an appropriate input for input at the user interface, cueing the user through the feedback system to provide the appropriate input, and controlling the at least one vehicle system based at least partially on the appropriate input, where controlling the at least one vehicle system includes applying active forces to the first wheel and the second wheel.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a block diagram of one embodiment of a vehicle including a vehicle control system and vehicle outputs for the vehicle control system;

FIG. 2 is a schematic of the vehicle of FIG. 1;

FIG. 3A is a schematic of one embodiment of a vehicle and road in a first state;

FIG. 3B is a schematic of the vehicle and road of FIG. 3A in a second state;

FIG. 3C is a schematic of the vehicle and road of FIG. 3A in a third state;

FIG. 4 is a flow chart for one embodiment of a method of controlling a vehicle;

FIG. 5 is a flow chart for another embodiment of a method of controlling a vehicle;

FIG. 6 is a flow chart for yet another embodiment of a method of controlling a vehicle;

FIG. 7 is a flow chart for yet another embodiment of a method of controlling a vehicle;

FIG. 8A is a schematic of one embodiment of a vehicle in a first state;

FIG. 8B is a schematic of the vehicle of FIG. 8A in a second state;

FIG. 8C is a schematic of the vehicle of FIG. 8A in a third state;

FIG. 8D is a schematic of the vehicle of FIG. 8A in a fourth state; and

FIG. 9 is a flow chart for yet another embodiment of a method of controlling a vehicle; and

FIG. 10 is a flow chart for yet another embodiment of a method of controlling a vehicle.

### DETAILED DESCRIPTION

In conventional automotive systems, major subsystems of a vehicle such as the brake controller or traction control system may be designed separately, and then subsequently combined at the time of integration into a vehicle. Such subsystems may not substantially interact with one another and may not be controlled based on the combined dynamics that affect each individual subsystem. Additionally, these subsystems may not be controlled on the basis of the combined effect of each subsystem on overall vehicle dynamics. For example, in conventional automotive systems, a brake controller may be solely responsible for vehicle control during a braking event.

In view of the foregoing, the inventors have recognized the benefits of a combined vehicle control system that incorporates overall vehicle dynamics due to the presence of strong interactions between automotive subsystems. In particular, the inventors have recognized the benefits of a combined vehicle control system that integrates an active suspension system and one or more other vehicle systems (e.g., braking systems, steering systems) to improve average traction and/or vehicle handling during braking events. Additionally, the combined vehicle control system may be employed to improve traction and handling in circumstances of low road friction (e.g., caused by a road feature or road surface conditions) or otherwise improve handling of a vehicle during certain events (e.g., turns, emergency maneuvers, etc.).

In some cases, a user of a vehicle (e.g., an operator) may provide input to control and/or operate one or more vehicle systems. For example, a user may provide input through a steering wheel to control a steering system of the vehicle. As another example, a user may provide input through one or more pedals to control a throttle, braking system, or transmission of the vehicle. A user may also be able to provide input through one or more buttons or switches or graphical user interfaces to control various parameters of vehicle systems. The inventors have appreciated that user input provided through a vehicle user interface plays an important role in the dynamics of a vehicle during many vehicle events, including encountering road features (e.g., potholes, road friction changes, bumps, curves, corners, etc.), turning, and emergency maneuvers. Usually, user input may override or overpower automated vehicle systems intended to control the dynamics of the vehicle in a safe manner. For example, a driver may overcorrect during oversteer or may apply brakes during hard turning, actions which may destabilize a vehicle. Accordingly, the effectiveness of vehicle control systems including safety systems like traction controls systems and braking systems may be reduced or negated by incorrect operator input during a road event.

In view of the above, the inventors have appreciated the benefits of a vehicle configured to cue a driver via a user interface to provide an appropriate input to control the vehicle. The appropriate input may be determined based on one or more parameters obtained by the vehicle. At least one other vehicle system may be controlled based at least partially on the appropriate input determined based on the one or more of the parameters. In this manner, coordination between user input and the at least one vehicle system may be provided, resulting in overall more effective vehicle control during a road event.

In some embodiments, a vehicle may include a plurality of wheels (e.g., two wheels, three wheels, four wheels, etc.). the plurality of wheels may include a first wheel and a second wheel that are configured to be controlled by one or more vehicle systems that are operatively coupled to the first wheel and the second wheel. The one or more vehicle systems may include, but are not limited to, braking systems, steering systems, active suspension systems, semi-active suspension systems, passive suspension systems, traction control systems, rear steering systems, transmission systems, and engine systems. In at least one mode of operation, the one or more vehicle systems may be employed to apply active forces to the first wheel and/or second wheel of the vehicle. The vehicle may also include a user interface and/or feedback system configured to provide feedback to the user. The user interface and/or feedback system may include a steering wheel, pedals, graphical user interface (e.g., on a dashboard or center console), transmission selector, buttons, and/or switches. In some embodiments, a feedback system may include a user interface or otherwise utilize components of the user interface to provide feedback to a user. The user interface and/or feedback system may be configured to provide a cue to the user of the vehicle to provide an appropriate input for current or future vehicle conditions, as discussed further below. The one or more vehicle systems are configured to be controlled based at least partially on the appropriate input and/or confirmation the user provided input in accordance with the appropriate input. In this manner, vehicle systems may be coordinated with a user, and the vehicle may instruct the user via the cues, so that the vehicle may be more effectively controlled.

According to exemplary embodiments described herein, an “appropriate input” may be a single input or combination of inputs a user is able to input at a vehicle user interface. In some embodiments, an appropriate input may include a steering input (e.g., a steering angle or steering torque). In some embodiments, an appropriate input may include a brake pedal input (e.g., an amount of pedal travel or a pedal force). In some embodiments, an appropriate input may include an accelerator pedal input (e.g., an amount of pedal travel or a pedal force). Of course, any suitable input may be cued for a user to input, as the present disclosure is not so limited.

According to exemplary embodiments described herein, a cue provided to a user via a vehicle user interface may be provided in any suitable manner understandable to the user. In some embodiments, the cue may be a tactile sensation provided to the user. For example, the cue may include a steering wheel torque, vibration (e.g., via a steering wheel or seat), vehicle body motion (e.g., via an active suspension system), and/or heating or cooling sensation (e.g., via a steering wheel or seat). In some embodiments, the cue may be a visual cue. For example, the cue may be provided by color, pattern displayed on one or more lights, and/or image or text displayed on a graphical user interface (e.g., on a dashboard) or a heads-up display. In some embodiments, a cue may be an auditory cue. For example, the cue may include a tone, chime, and/or voice provided by a speaker.

According to exemplary embodiments described herein, an appropriate input for cueing to a user may be determined by at least one processor of the vehicle based on one or more parameters. In some embodiments, the appropriate input may be determined by the vehicle based on input from one or more vehicle sensors (e.g., information representing a current state of the vehicle). For example, the one or more sensors may include accelerometers, tachometers, speedometers, wheel spin sensors, wheel position sensors, or any other suitable sensors providing information about the vehicle. In some embodiments, the appropriate input generating the cue may be reactive to the information provided by the one or more vehicle sensors. For example, the appropriate input may be based on a detection of a yaw moment exceeding a yaw moment threshold. Of course, any suitable sensor input and/or thresholds may be employed, as the present disclosure is not so limited.

In some embodiments, an appropriate input for cueing a user may be determined alternatively or additionally to vehicle sensor parameters using forward-looking road information (e.g., from a forward-looking road sensor). For example, a forward-looking road sensor may include LIDAR, radar, ground-penetrating radar, cameras, any/or any other sensor configured to collect information regarding a road in the vehicle's path. In some embodiments, the appropriate input generating the cue may be proactive based on the information provided by the forward-looking road sensors. For example, the appropriate input may be based on a detected road feature such as a pothole by the forward-looking road sensors. In some embodiments, the appropriate input may be determined alternatively or additionally based on reference road information corresponding to a vehicle location (e.g., as measured by GNSS, terrain-based localization, etc.). In some embodiments, the appropriate input generating the cue may be proactive based on the location of the vehicle and reference road information. For example, the appropriate input may be based on a prediction the vehicle is about to encounter a road feature such as a pothole based on the obtained reference road information. Of course, an appropriate input may be determined using any suitable reactive and/or proactive parameters in one or more modes of operation, as the present disclosure is not so limited. In some embodiments, a reactive vehicle system may control one or more vehicle systems within 50-100 msec though other timings are also contemplated.

In some embodiments, a method of operating a vehicle may include determining an appropriate input at the user interface. As discussed above, the appropriate input may be an input configured to be input by a user to control the vehicle. The appropriate input may be based on one or more parameters, and may be proactive or reactive. The method may include cueing the user through the user interface to provide the appropriate input. The cue may be tactile, visual, and/or auditory. The method may include controlling at least one vehicle system based at least partially on the appropriate input. Controlling the at least one vehicle system may include applying active forces to a first wheel and a second wheel of the vehicle though other portions of the vehicle may be controlled in some applications. In some embodiments, the at least one vehicle system may include an active suspension system configured to adjust a contact force between the first wheel and second wheel and the road. In some embodiments, the method may includer determining if the user provided the appropriate input at the user interface prior to controlling the vehicle based on the appropriate input. In this manner, a vehicle may be controlled by the user via a cued input and at least one vehicle system in a coordinated manner.

As used herein an “active force” is a force that is generated by a vehicle system independently of an external force inputs on a vehicle. For example, an active force may include applying force to a wheel via an active suspension system actuator. As another example, and active force may include applying braking force to a wheel with a braking system. As used herein a “passive force” is a force may be generated by a vehicle system automatically based on external force inputs on a vehicle. For example, a suspension system spring (e.g., coil spring, air spring, etc.) may generate spring force in response to a wheel being moved by a road feature (e.g., a bump, curve, etc.). As another example, a suspension system shock may generate a passive damping force (e.g., forces that resist movement of a wheel and/or vehicle body) in response to a wheel being moved by a road feature, though it is noted that an active suspension system may apply damping forces that resist motion of an associated mass. According to exemplary embodiments described herein, vehicle systems may apply active and/or passive forces depending on a mode of operation of the vehicle system. For example, an active suspension system may be operated in a first mode where an actuator is employed to apply active forces to the vehicle and in a second mode where only passive forces are applied based on external force inputs on the vehicle. In some operational modes, vehicle systems may generate a combination of active and passive forces.

As used herein, a “road event” is any event that may occur while a vehicle is traveling on a roadway. In some embodiments, a road event may include encountering a road feature. A road feature is any non-nominal road condition that may be encountered by a vehicle while traveling on a road surface. For example, a road feature may include, but is not limited to rough pavement, potholes, manhole covers, bumps, uneven lanes, variable road materials (e.g., dirt, gravel, pavement, concrete, metal, etc.), road coverings (e.g., snow, ice, salt, sand, dirt, water, etc.), and/or any other appropriate feature that may result in changes in the forces applied to a vehicle traversing a road surface. In some embodiments, a road event may include a turn (e.g., a corner). In some embodiments, a road event may include a braking event. A braking event is any instance or period of time in which one or more brakes of a vehicle are applied, e.g., to decelerate or stop the vehicle or the vehicle is decelerated by applying a drag to one or more rotating components in the drive train (e.g., during coasting). A braking event may have any duration, as the present disclosure is not so limited. In some embodiments, a braking event may include a single application of the brakes or multiple applications of the brakes, as the present disclosure is not so limited.

In addition to the above, the inventors have appreciated that during some road events a yaw moment may be generated on a vehicle. For example, a rear axle of the vehicle may start sliding if too great of a steering input is applied to the vehicle. As another example, if a vehicle encounters a road feature with different frictional coefficients on two sides of the vehicle, application of a braking force may generate a yaw moment on the vehicle due to the different amounts braking force generated on the two sides of the vehicle. Such yaw moments may generally make a vehicle more unstable.

In view of the above, the inventors have appreciated the benefits of a vehicle including an active suspension system and a rear suspension system. The active suspension system and rear steering system may be configured to apply active forces to one or more wheels of a vehicle (e.g., one or more rear wheels) to control the vehicle during a road event. In some embodiments, the active suspension system and rear steering system may be controlled based on a determined yaw moment. The rear steering system may be employed to counter the destabilizing effects of the yaw moment. In some embodiments, control of the rear wheels of the vehicle may counter the effects of a road feature while turning, but such steering may produce the perception of a lateral offset for a user of the vehicle. In some such embodiments, active forces with the active suspension system may be applied to minimize or otherwise reduce the perception of the lateral offset.

In some embodiments, a vehicle includes a first wheel and a second wheel. The vehicle may also include a rear steering system configured to apply steering force to one or more rear wheels of the vehicle (which may include one or both of the first wheel and second wheel). The vehicle may also include an active suspension system operatively coupled to the first wheel and second wheel configured to apply active forces to the first wheel and second wheel in at least one mode of operation. The active suspension system may be configured to adjust a normal component of a wheel contact force for the first wheel and second wheel. The vehicle may also include at least one processor configured to determine a yaw moment of the vehicle and control the rear steering system and the active suspension system based at least partially on the yaw moment, as discussed further below.

In some embodiments in which a yaw metric (e.g., a yaw moment) exceeds a threshold, the vehicle control system may apply vertical force to one or more wheels with one or more of the active suspension actuators of the vehicle. In some embodiments, the force may be applied in a twist pattern over an extended duration, for example if the split friction coefficient scenario persists. In the twist pattern, a normal load may be increased on two wheels located at opposing corners of the vehicle. In some embodiments, the vehicle control system may apply more normal force to the front wheel encountering the lower friction surface and thus increasing the ability of the corresponding tire to produce longitudinal force. As recognized by the inventors, in some operating conditions, the application of a twist force may generate a yaw moment of the vehicle countering the externally applied yaw moment. In this manner, the application of twist force may reduce the perception of a lateral offset generated by the application of rear steering to one or more rear wheels.

In some embodiments, a vehicle may use force from an active suspension system, for example arranged in the twist direction such that two wheels on opposite corners of the vehicle are pushed up and the other two are pushed down effectively simultaneously, to alter the longitudinal forces on the vehicle in a way that mitigates undesired yaw behavior of the vehicle even under general braking situations. As an example, road crown or rutting can sometimes create a lateral pull during a braking event, and the active suspension may be used to apply a twist force to mitigate the effect. This mitigation may occur in two forms—either it may mitigate the effect and attempt to reduce metrics such as mentioned above, for example peak yaw rate or peak lateral deviation from the desired path, but it may also try to counteract the perceived behavior, for example, by mitigating the steering torque created during such a scenario. Communication between different systems (e.g., between a rear steering system and an active suspension system) in the vehicle is an important aspect in this scenario, since the braking system, the steering system, rear steering system, and the active suspension system all can induce yaw and must ideally work in a synchronous manner to decide how to act.

In some embodiments in which a yaw metric exceeds a threshold, a vehicle control system may control an active suspension system to apply a force on both tires on the side encountering low friction for short durations of split friction scenarios. In such embodiments, the active suspension system may accelerate the vehicle in the roll direction. This roll acceleration may allow a temporary increase of the normal load on the wheels located on the low friction surface, providing an improvement in braking performance and a reduction in yaw metric for a limited period of time. For example, in some embodiments, such a roll acceleration may be generated by the active suspension system for 0.5-1.0 seconds or more. In coordination with this roll acceleration, a rear steering system may apply steering force to one or more rear wheels to counter the remaining yaw metric. After the application of a roll acceleration, the normal force load on the wheels located on the low friction surface may decrease temporarily, making this particular embodiment well suited for short duration split friction scenarios or scenarios where braking may be required only for a short duration of time. In some embodiments, a vehicle control system may apply a roll acceleration to the vehicle based on reference road information or forward-looking road information.

In some embodiments, a vehicle control system may prioritize one subsystem of a vehicle over another subsystem of the vehicle. In this manner, one such subsystem may be assigned as a master controller to achieve a minimum functionality even in the event of failure or non-availability in one or more other subsystems. For example, the braking system may be assigned as the master control system. As a master control system, the braking system may rely on other systems, such as the active suspension system, steering system, rear steering system, etc., when there is communication that clearly indicates the availability of the other system. The braking system may be configured go into a failsafe, more conservative, mode when the correct status response is not received from another system such as, for example, the active suspension system. In this manner, control of the braking system may be prioritized over the active suspension system such that a minimum effectiveness of the braking system may be maintained. However, in some embodiments, other controllers may also be responsible for the decision making provided proper safeguards for operation according to automotive functional safety guidelines are implemented, and in such a way that the active suspension controller, steering controller, and/or another controller such as a vehicle-level ECU may be used for this purpose.

The inventors have recognized that the coefficient of friction between the tire and the ground, μ, may depend on many factors, including the tire, the vehicle speed, and the surface conditions of the road. For example, different types of asphalt coatings can have different coefficients of friction. For example, different types of asphalt coatings can have different μ, and the μ for a given surface or road section may change substantially with environmental conditions, for example due to rain, snow, mud and/or ice. The total longitudinal tire force in a direction parallel to a direction of travel of the vehicle or lateral force (e.g., transverse force in a turning direction of the vehicle) available to a vehicle at any given tire is based on the coefficient of friction μ and a normal force on the tire. The nature of tire forces is such that the longitudinal force created at a certain longitudinal slip is related to the normal force on that tire through a degressive map. That is, the higher the normal force on the tire, the higher the longitudinal force, but the increase is less than directly proportional. Accordingly, the inventors have recognized that in some instances, a fluctuating normal force load with a given normal force average load may create less braking force or turning force than the same average normal force load without fluctuation. According to some embodiments herein, a vehicle control system may employ an active suspension system to increase an average normal force load or reduce fluctuation in a normal force of a tire.

The inventors have also recognized that during a braking or cornering event, a vehicle may decelerate, accelerate, and/or corner. An acceleration of the vehicle may induce an inertial force on the vehicle, which may result in an overturning moment, since the center of gravity of the vehicle may be on a different plane relative to the tire contact point or patch. This overturning moment may be balanced by differences in the normal forces on the tires. For example, during a braking event the front tires of a vehicle may experience more normal force than the rear tires. As another example, during acceleration the rear tires may experience more normal force. As still another example, during cornering the outside tires experience more load. The effect of changing normal force based on the vehicle dynamics during deceleration, acceleration, and cornering is referred to herein as load transfer. According to some embodiments herein, a vehicle control system may employ an active suspension system to modify and otherwise employ load transfer to temporarily increase braking force, increase average braking force, assist with cornering, and/or mitigate an overturning moment and reduce chances of a rollover.

The inventors have also recognized that any acceleration of a sprung mass or unsprung mass of a vehicle in the vertical, pitch, or roll directions may also cause inertial moments that ultimately may be carried by one or more tires of the vehicle. Thus, if the vehicle body accelerates downward, such as for example during a hill cresting, the normal load on all tires decreases temporarily. This effect is temporary since the average load on the vehicle is equal to the total mass of the vehicle. At the same time, this temporary effect is important in that bouncing of the tires or of the vehicle body may cause temporary increases and decreases of the normal load. As discussed previously, fluctuation in normal load on a tire may be detrimental to the behavior of the vehicle as it decreases the ability of the vehicle to induce longitudinal and lateral forces. At the same time, the temporary effect of normal load increases or decreases may be used to advantage if correctly timed such that the temporary increase in normal force corresponds with a temporary desire for higher longitudinal force (e.g., braking force) or lateral force (e.g., turning force), for example. According to some embodiments herein, a vehicle control system may employ an active suspension system to temporarily increase normal force load on a tire to correspond to a temporary call for greater tire force in the plane of the road. For example, in some embodiments, greater braking force may be desired in an emergency stopping situation, or during a temporary braking event where the duration of the braking event is determinable. Additional examples of such control and factors for determining when to implement such control are discussed further herein.

The inventors have also recognized that applying the brakes on one side of the vehicle differently from the other side induces a yaw moment in the vehicle. That is, different braking forces on opposite sides of the vehicle generates a yaw moment in the vehicle. Such a difference in braking force may be caused by variation in road conditions between the opposing sides of the vehicle (e.g., ice patch, puddle, pothole, or other road feature). According to some embodiments herein, a vehicle control system may employ an active suspension system to increase a normal force load on a tire on a side of the vehicle experiencing lower braking force, and may also apply rear wheel steering force to counter the effects of the yaw moment. By increasing the normal force load on the tire on the side of the vehicle with lesser braking force, additional braking force may be generated to balance the braking forces and reduce the yaw moment. Additionally, by countering the yaw moment with rear steering, the vehicle may be kept on a straight path. Accordingly, a vehicle control system according to exemplary embodiments described herein may be used to delay the occurrence of rollover, prevent vehicle oversteer, and reduce yaw induced by braking on surfaces with a range of surface friction coefficients.

According to exemplary embodiments described herein, active suspension systems are suspension systems that can vary the normal force exerted on at least one wheel (and tire) of the vehicle by creating a relative force between the sprung and unsprung mass that includes the wheel. In some embodiments, an active suspension system may include hydraulic, electromagnetic, electromechanical, or hydroelectric active suspension actuators. In some embodiments, an active suspension system may include electric or hydraulic active roll actuators. In some embodiments, an active suspension system may include semi-active variable damper systems such as magneto-rheological or variable orifice systems. Of course, an active suspension system may include any suitable actuators, springs, and/or dampers to adjust a normal force applied to a wheel and tire of a vehicle, as the present disclosure is not so limited. In some embodiments, an active suspension may have a rapid response time and the ability to produce dynamic responses to an input. Depending on the embodiment, the response time may be less than 50 milliseconds, less than 25 milliseconds or less than 10 milliseconds to a command for a step change in applied vertical force (e.g., to the vehicle body), where the response time is defined as the delay between a command for a step change and reaching 90% of the steady state output. Embodiments disclosed herein provide such capability. In addition, the present active safety suspension system can exploit the multiple degrees of freedom on a vehicle by using multiple actuators in a coordinated fashion. In some embodiments, active suspension system responses can be vectored normal to the road to produce instantaneous or short duration (e.g., approximately half the period of the natural frequency of the vehicle body on the main suspension springs) changes in wheel force tailored and timed precisely to the vehicle state parameter information the suspension system determines or receives from other vehicle subsystems (e.g., rear steering system, electronic braking system, steering system, etc.).

In some embodiments, a vehicle control system may include one or more driver assistance systems that aid driver tasks such as directional and speed control inputs such as steering, braking, or acceleration. In some embodiments, a vehicle control system may employ the one or more driver assistance systems in control of a braking system and/or active suspension system. In some embodiments, the one or more driver assistance systems may provide information to the braking system and/or active suspension system. For example, in some embodiments, a driver assistance system may provide forward-looking road information to the vehicle control system. The forward-looking roading information may include upcoming road features, information regarding other vehicles, information regarding obstacles, information regarding turns, or any other information. A driver assistance system may include, but is not limited to, automatic braking systems (e.g., reacting for example to an unseen obstacle), lane assist systems (e.g., maintaining the vehicle in the driving lane if no other input is provided), active steering systems (e.g., autopilot, automated lane keeping, etc.), and blind spot warning systems (e.g., alerting the driver to a vehicle in their blind spot behind). In some embodiments, a driver assistance system may be operated in coordination with one or more other vehicle systems. In some embodiments, a vehicle may include an active steering system that may either steer a vehicle without driver input or provide feedback to the driver to induce a driver to steer in a particular direction, for example, by providing torque feedback at the steering wheel. Such active steering systems can include steer-by-wire systems, add-angle steering systems, and electronic power assisted steering (EPAS).

According to exemplary embodiments described herein, a vehicle control system may be operated by one or more processors. The one or more processors may be configured to execute computer readable instructions stored in volatile or non-volatile memory. The one or more processors may communicate with one or more actuators associated with various elements of the vehicle (e.g., braking system, active suspension system, steering system, rear steering system, driver assistance system, etc.) to control activation and movement of the various elements of the vehicle. The one or more processors may receive information from one or more sensors that provide feedback regarding the various elements of the vehicle. For example, the one or more processors may receive position information regarding the vehicle from a Global Navigation Satellite System (GNSS) or other positioning system. The sensors on board the vehicle may include, but are not limited to, wheel rotation speed sensors, inertial measurement units (IMUs), optical sensors (e.g., cameras, LIDAR), radar, suspension position sensors, gyroscopes, etc. In this manner, the vehicle control system may implement proportional control, integral control, derivative control, a combination thereof (e.g., PID control), or other control strategies of various elements of the vehicle. Other feedback or feedforward control schemes are also contemplated, and the present disclosure is not limited in this regard. Any suitable sensors in any desirable quantities may be employed to provide feedback information to the one or more processors. Information from sensors may be employed in coordination with desirable processing techniques (e.g., machine vision). The one or more processors may also communicate with other controllers, computers, and/or processors on a local area network, wide area network, or Internet using an appropriate wireless or wired communication protocol. It should be noted that while exemplary embodiments described herein are described with reference to a single processor, any suitable number of processors may be employed as a part of a vehicle, as the present disclosure is not so limited.

In addition to the above, the inventors have also recognized benefits of road preview information for control of vehicle systems including active suspension systems. In some embodiments, a vehicle control system may employ road information in the control of the type and duration of activation of the active suspension system during a braking event. The vehicle control system may employ road information from one or more sources that may allow for selection from among various control strategies. In some embodiments, the road information may be reference road information that is obtained, for example, from a cloud service, server, or other vehicle. For example, in some embodiments, reference road information may be downloaded for a portion of a road surface ahead of the vehicle. The reference road information may be received from another vehicle located ahead of the vehicle downloading the information. In some embodiments, the reference road information may include crowd-sourced road conditions. In some embodiments, the reference road information may include weather analysis based on local or hyper-local weather maps. In some embodiments, the road information may be sourced from one or more forward-looking sensors onboard the vehicle. For example, such forward-looking sensors may include, but are not limited to, cameras, LIDAR, radar, and ground penetrating radar. The forward-looking sensors may be configured to sense road features, and other characteristics of a road surface in front of the vehicle. Various control strategies may be implemented based on information included in the forward-looking and/or reference road information. For example, different control strategies may be implemented depending on if a known pattern of slippery road about to be encountered is short or long in extent, if the pattern of slippery road alternates between the left and right sides of the vehicle, or if a lower friction surface of the slippery road surface is only on one side of the vehicle.

In some embodiments, a vehicle control system employing reference road information may rely on systems and methods capable of accurate, high resolution (e.g., in some embodiments equal to sub-1-meter resolution), and repeatable localization of the vehicle. In some embodiments, a vehicle may include a GNSS to allow the vehicle to be localized. In some embodiments, a vehicle may employ triangulation with radio signals (e.g., cellular signals). In some embodiments, a vehicle may employ visual identification of landmarks (e.g., signs, mile markers, etc.) to assist in localization. In some embodiments, environmental characteristics, including surface characteristics of a road or other terrain (e.g., elevation changes, slopes, banks, locations of surface extrusions such as, e.g., bumps and/or depressions, and other surface details) may be utilized for localization, e.g., to identify a location of a vehicle (e.g., a vehicle's position on a road), much like a fingerprint or facial features may be used to identify a person. Such surface-based localization may include, in some implementations, detecting a sequence of surface characteristics of a road surface traversed by a vehicle, followed by matching of the detected sequence to a sequence of reference surface characteristics that is stored in a previously generated reference map. The sequence of road characteristics may be detected by an active suspension system. For example, feedback from the active suspension system may be employed to characterize the position of the vehicle based on a previously generated reference map.

In some embodiments, reference road information may be obtained by the vehicle based on the vehicle's present location. That is, once the vehicle is localized, the vehicle may download a buffered local map of reference road information that is relevant to the vehicle at its current location. According to such an embodiment, less data may be transferred to the vehicle compared with downloading a global reference map. As the vehicle travels, continued localization may allow the vehicle to buffer additional reference road information in an area surrounding the vehicle. In some embodiments, all reference road information may be downloaded within a predetermined radius of the vehicle. In some embodiments, reference road information may be buffered based on a direction of travel of the vehicle. For example, road information for a road the vehicle has already passed may not be buffered. In some embodiments, reference road information may be generated and shared by a plurality of vehicles traveling over road surface. For example, in some embodiments, a vehicle may upload reference road information after passing over a road surface, such that the reference road information may be updated for other vehicles that subsequently travel that road surface. In this manner, the reference road information may be dynamic and update to match the current conditions on a road surface. In other embodiments, a static map with less frequent updates may be employed, as the present disclosure is not so limited.

In some embodiments, forward-looking road information may be employed by a vehicle control system to increase coordination in vehicle handling and safety activity during road events. The forward-looking information may be sourced from one or more forward-looking sensors. The forward-looking sensors may include vision sensors (e.g., stereo vision cameras), distance measurement systems such as, for example, adaptive cruise control radar, sonar, or LIDAR, and any other suitable sensor systems. In some embodiments, a processor maybe configured to detect a road feature based on the forward-looking road information. For example, a processor may detect an object such as another vehicle, a pedestrian, or a stationary object and determine its spatial relationship with respect to the vehicle (e.g., a distance measurement using stereo vision techniques or using a radar sensor). In some embodiments, a processor may also predict the kinematics of the vehicle and the object based on measurements and analysis, for example, during a braking event.

In one embodiment, a surface with different frictional coefficients, μ, on one side of the vehicle relative to the other side may be encountered (referred to as a “split μ” scenario). In some scenarios, the difference in frictional coefficients may be large, for example with a μ of 0.7-1.0 on one side of the vehicle, and a μ of 0.2-0.4 on the other side (e.g., a μ difference of 0.5 or greater). In such scenarios, if a reduction in vehicle speed is desired, the longitudinal tire force (e.g., braking force) achievable on the side with lower surface μ may be lower than the one on the side with higher μ. Such a disparity in longitudinal tire force may cause a yaw moment that may effectively pull the vehicle towards the higher μ surface. This may lead to a deviation from a desired vehicle path, which may even be sufficient to cause the vehicle to spinout and/or enter a different travel lane. In some embodiments, a vehicle control system may calculate a yaw metric based on the estimated frictional coefficients on each side of the vehicle. A yaw metric may be, for example, a threshold maximum yaw rate or yaw acceleration, a threshold difference between braking force on each side of the vehicle, or a threshold maximum lateral offset from the desired path, or another suitable metric describing the difference between the desired and actual path traveled by the vehicle. In some embodiments, a vehicle control system may determine if the yaw metric exceeds a threshold (e.g., a threshold yaw rate, threshold difference in braking force, etc.) and may control a rear steering system and an active suspension system in order to reduce the yaw metric to below the threshold during the braking event.

An emergency lane change scenario occurs when a vehicle is steered form one lane into an adjacent one at the highest possible speed without causing the vehicle to spin or roll over. This is particularly difficult for vehicles with a high center of gravity, such as trucks and SUVs. Conventional braking systems apply the brakes to steer the vehicle out of the turn should conditions for rollover be identified. This may lead to the vehicle sliding out of the turn and also slowing down. The inventors have recognized that, in some embodiments, an active suspension system and rear steering system may be employed to improve stability of a vehicle in such a scenario in coordination with a braking system. In some embodiments, a vehicle control system may command the active suspension system to lower the center of gravity of the vehicle, thus mitigating rollover and tire slip problems at the same time. In some embodiments, a vehicle control system may command the active suspension system to apply force to the wheels of the vehicle in such a way as to reduce roll acceleration of the vehicle and thus reduce the risk of rollover. In some embodiments, a vehicle control system may command the active suspension system to apply force in a twist pattern in such a way as to reduce the propensity of the vehicle to oversteer. In some embodiments, a vehicle control system may command the rear steering system to apply steering force to one or more rear wheels to increase lateral tire force and/or to counter oversteer as a result of excessive steering input.

Similar to emergency lane change scenarios, during handling maneuvers (for example in spirited driving), the inventors have recognized that it is beneficial to achieve increased traction both in the longitudinal and lateral direction, while keeping the vehicle moving in the direction the driver wants it to go and maintaining understeer targets for the vehicle. In conventional vehicles, stability control systems apply braking torque to achieve this objective, which in turn slows the vehicle down, which may be undesirable for spirited driving (e.g., in a race scenario). In some embodiments, a vehicle control system may use an active suspension system to apply an appropriate amount of twist force and may use a rear steering system to apply an appropriate amount of rear steering force. In some embodiments, the twist force may be applied such that an axle, with a tire in need of traction, is evenly loaded. In some embodiments, the cornering load may be reduced on the front tires during cornering (equivalent to moving a virtual roll stabilizer of the vehicle to the rear of the vehicle but doing so by applying active suspension forces), leading to higher lateral force tolerance due to more even distribution of normal load on that axle. In a similar fashion, in some embodiments, twist force may be used to create a more even normal load distribution on the rear axle during acceleration in a rear-drive vehicle, or more neutral normal load distribution for a 4-wheel-drive vehicle. In some embodiments, the vehicle control system may determine an amount of twist force to apply by determining the force required to meet understeer targets (which in general may be desired to “steer out of the turn”). Such an application of twist force may be equivalent to moving a roll stabilizer to the front of the vehicle or shifting roll moment distribution to the front of the vehicle. In some embodiments, the vehicle control system may determine an amount of twist force to apply by determining a force required to achieve a greatest possible wheel traction. For example, in some embodiments, the vehicle control system may shift normal load distribution rearward at the beginning of a turn (e.g., during a braking phase), then shift normal load distribution to the center of the vehicle at or near a mid-point in the turn, and then shifting normal load distribution to the front of the vehicle during the exit from a turn.

In some embodiment, an active suspension system of a vehicle may be controlled based on one or more measured inputs (e.g., from sensors) during a road event. In some cases, it may not be desirable to control an active suspension in response to all road events, as the active suspension system may provide little benefit in some minor braking cases at the expense of greater power consumption. In some cases, it may not be desirable to control an active suspension system in response to major road events, where such control may reduce an overall braking or steering effectiveness of the vehicle. Accordingly, the inventors have recognized that one or more thresholds may be employed to activate and deactivate the active suspension system in response to a road event such as a braking or cornering event. In some embodiments, a vehicle control system may determine that a braking force demand for a wheel exceeds a threshold braking force during a braking event. According to such an embodiment, upon determining that the braking force demand exceeds the threshold braking force, the system may adjust a normal component of a wheel force at one or more wheels of the vehicle with the active suspension system to increase an average traction force at a first wheel during the braking event. In some embodiments, a vehicle control system may determine that the braking force demand does not exceed the braking force threshold and may disable or otherwise not activate the active suspension system response to a braking event. In some embodiments, a vehicle control system may determine that a steering force demand for a wheel exceeds a threshold steering force during a cornering event. According to such an embodiment, upon determining that the steering force demand exceeds the threshold steering force, the system may adjust a normal component of a wheel force at one or more wheels of the vehicle with the active suspension system to increase an average traction force at a first wheel during the cornering event.

In some embodiments, a vehicle control system may be configured to determine the size and/or duration of a road feature from reference road information and/or forward-looking road information. The size and/or duration of the road feature or anomaly may affect a control strategy implemented by the vehicle control system. For example, a relatively small size road feature that is expected to last on the order of less than 1 second may call for a temporary increase in normal load on a tire by modifying pitch and/or roll acceleration of a vehicle body. As an alternative example, a long road feature that is expected to last greater than 1 second may call for application of a twist force, so as to avoid generating pitch or roll moments on the vehicle. Accordingly, in some embodiments, a vehicle control system may determine a mode of operation based on a road feature magnitude and/or duration threshold. In some embodiments, the magnitude and/or duration of the road feature may also be employed to activate or disable the response of the active suspension, during the duration of a braking event, to encountering a road feature. According to some such embodiments, upon determining whether a road feature magnitude exceeds an activation threshold, the active suspension system may be used for the purpose of increasing the normal component of the wheel force. Correspondingly, if the feature magnitude does not exceed the activation threshold for a duration of a braking event, the active suspension system may not respond to such features.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

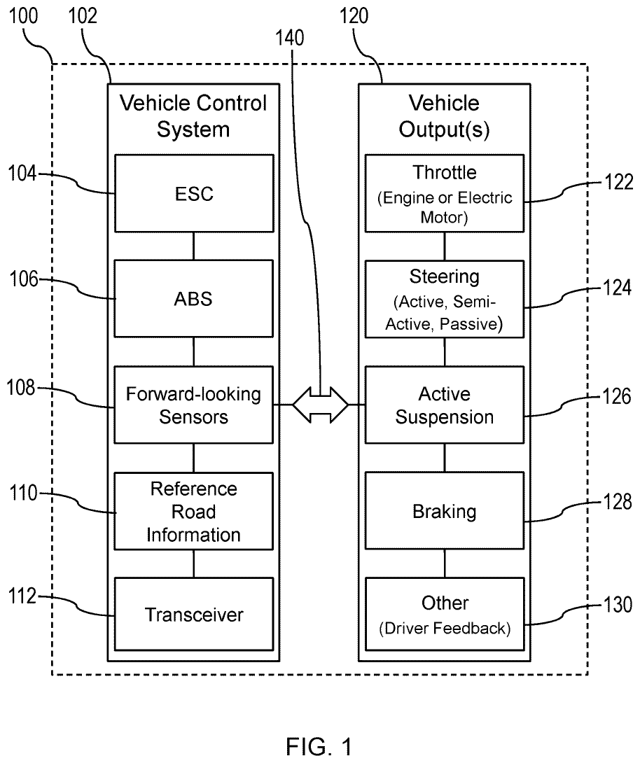

FIG. 1 is an exemplary block diagram of one embodiment of a vehicle 100 including a vehicle control system 102 and vehicle outputs 120 for the vehicle control system. The vehicle control system may include at least one processor configured to execute computer readable instructions and control the vehicle outputs 120. As shown in FIG. 1, the vehicle control system may include an electronic stability control system 104, and anti-lock braking system (ABS 106). The electronic stability control system may be configured to automatically apply the brakes to help steer the vehicle where the driver intends to go when there is a loss of traction. The ABS is configured to inhibit wheels from locking up and sliding. As shown in FIG. 1, the vehicle control system may also include a forward-looking sensor 108. The forward-looking sensor may sense road characteristics, road features, or objects in front the vehicle, which may be provided to the at least one processor as forward-looking road information. In the embodiment of FIG. 1, the vehicle control system may also include reference road information 110 that may be stored in memory onboard the vehicle control system. In some embodiments as shown in FIG. 1, the vehicle control system may also include a transceiver 112 configured to send or receive information. In some embodiments, the transceiver 112 may be configured to receive the reference road information from another vehicle or cloud service (e.g., one or more servers). The transceiver may be configured to communicate wirelessly via any suitable wireless protocol, as the present disclosure is not so limited.

As shown in FIG. 1, the vehicle may include a plurality of vehicle outputs 120 which are controlled by the vehicle control system. In particular, the vehicle outputs may include a throttle 122 (which may include throttle of an engine or electric motor), steering system 124 (which may include active steering, semi-active steering, passive steering and/or rear steering), active suspension system 126, braking system 128, and other outputs 130 such as driver feedback. The vehicle control system may be configured to control these vehicle outputs individually or in various combinations. By controlling the various vehicle outputs in combination, the vehicle control system may provide enhanced stability compared to a vehicle with independent control of each system. In some embodiments, the vehicle control system may prioritize certain outputs. For example, the braking system may be prioritized over steering or the active suspension system. In this manner, the more important systems for a given scenario may be prioritized for control, with the possible assistance of other vehicle outputs. The operational modes and control schemes for the vehicle outputs are discussed further below.

In some embodiments as shown in FIG. 1, the vehicle may include a real-time bi-directional communication system 140 that enables communication between the various subsystems and vehicle outputs. The communication system may employ any appropriate connection protocol including, for example, a controller area network (CAN), a local interconnect network (LIN), a vehicle area network (VAN), FlexRay, D2B, Ethernet, a direct communication link (such as wires and optical fibers), or a wireless communication link. The communications system may be employed to share information between subsystems, like ABS or ESC, while receiving vehicle state parameters or other information from these same or other systems. Information that may be shared between subsystems and employed for vehicle output control includes, but is not limited to, for example, vehicle yaw and yaw rate, vehicle velocity, vehicle acceleration, vehicle lateral acceleration, steering wheel position, steering wheel torque, if the brakes are being applied, and suspension spring compression. The vehicle control system may control the active suspension system 126 based on information from the vehicle such as the state of one or more vehicle subsystems, such as ABS 106 and ESC 104, that engage during unusual events. For example, the system may provide different control of the wheels and vehicle if one or more systems are engaged.

In addition to the above, in some embodiments an active suspension system 126 may sense several parameters relating to the road, wheel, vehicle body movement, and other parameters that may benefit other vehicle subsystems. Such information may be transmitted from the active suspension system to the other subsystems via the communication system 140. Other vehicle subsystems may alter their control based on information from the active suspension system. As such, bidirectional information may be communicated between the active safety suspension system and other subsystems, and control of both the active suspension system and the other vehicle systems may be provided based at least partially on this information transfer. For example, the application of the brakes of the braking system 128 by the ABS 106 may be synchronized with an increase of wheel force by the active suspension system for one or more wheels. As another example, application of steering with the steering system 124 may be synchronized with an increase of wheel force by the active suspension system for one or more wheels.

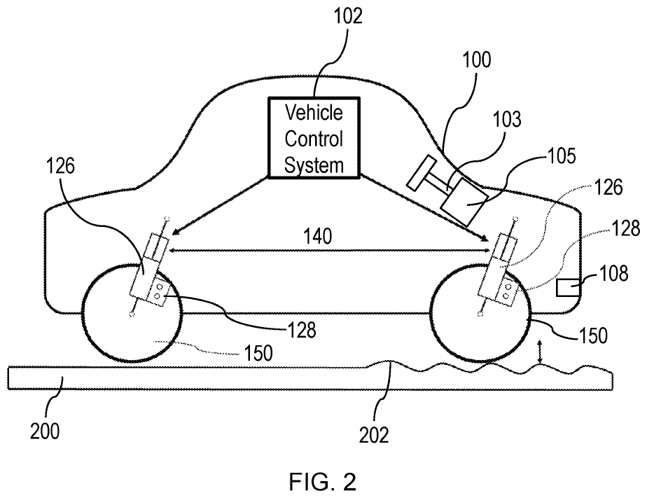

FIG. 2 is a schematic of the vehicle 100 of FIG. 1. As shown in FIG. 2, the vehicle includes a vehicle control system 102 that may communicate with various subsystems via a communication system 140. As shown in FIG. 2, the vehicle includes an active suspension system 126 that is operatively coupled to the wheels 150 of the vehicle. In particular, active suspension actuators may be operatively interposed between each wheel of the vehicle and the vehicle body, such that separate actuators of the active suspension may independently control separate wheels of the vehicle. The vehicle may also include a braking system 128. The braking system may include independent brakes coupled to each of the vehicle wheels 150, such that a braking force may be applied to each wheel independently. According to the embodiment of FIG. 2, the vehicle may also include a forward-looking sensor 108. The forward-looking sensor 108 may be at least one camera, LIDAR, radar, a combination thereof, or other sensor that may be configured to sense forward-looking road information that may be employed by the vehicle control system 102.

According to the embodiment of FIG. 2, the vehicle also includes a steering system 105 including a steering wheel 103. The steering wheel 103 may form a part of a user interface of the vehicle 100. The user interface may be used to provide user input to the vehicle control system and to control various portions of the vehicle. In some embodiments, the user interface may be employed to provide feedback to a user. In particular, in some embodiments, the user interface may be employed to cue the user to provide an appropriate input at the user interface. Such an arrangement may be beneficial where a passive or semi-active vehicle system is employed that is controlled largely by user input. For example, in the embodiment of FIG. 2, a steering torque may be applied to the steering wheel 103 to cue the user to provide an appropriate steering input. In some embodiments, the steering system 105 includes a rear steering system configured to control one or more rear wheels of the vehicle. Though other user interfaces and inputs may also be used as described previously.

As shown in FIG. 2, the vehicle may traverse over a road 200. The road surface may include one or more road features 202. The road features 202 may cause fluctuations in the normal load of a wheel 150 of the vehicle (e.g., by accelerating the wheel upward and/or downward). In some embodiments, a road feature may reduce an effective frictional coefficient between a wheel 150 and the road 200.

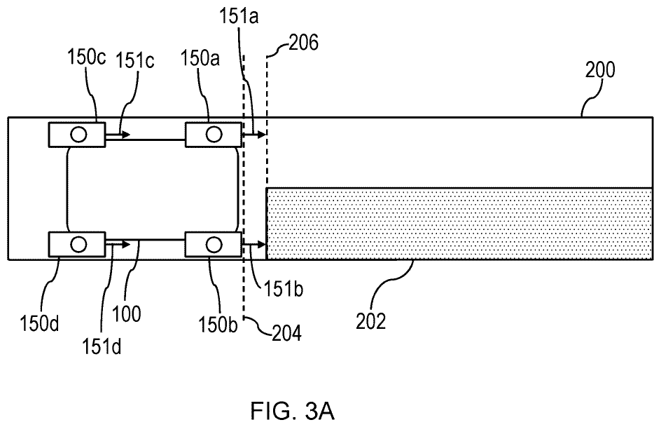

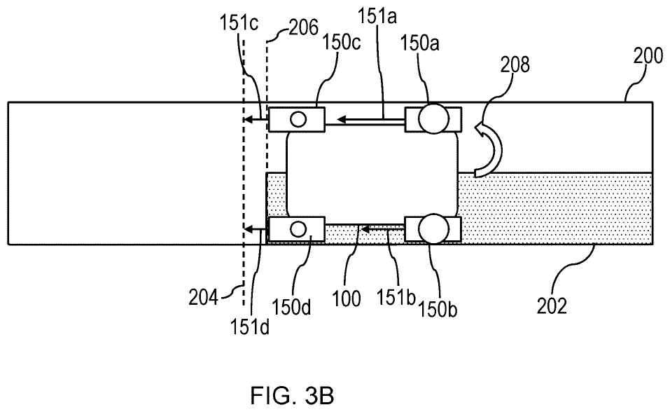

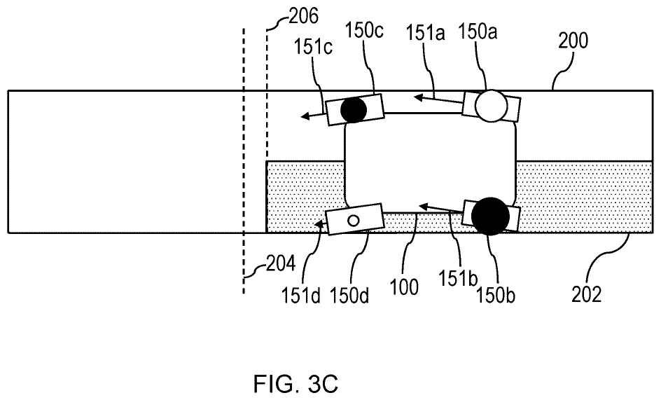

FIG. 3A is a schematic of an exemplary embodiment of a vehicle 100 and road 200 in a first state. As shown in the schematic of FIG. 3A, the vehicle includes a first wheel 150a (e.g., front left wheel), a second wheel 150b (e.g., front right wheel), a third wheel 150c (e.g., rear left wheel), and a fourth wheel 150d (e.g., rear right wheel). The size of the circles within the wheels shown in FIGS. 3A-3C is representative of a normal component of a wheel force at a respective wheel. The arrows 151a, 151b, 151c, 151d associated with each wheel are representative of a longitudinal force on the wheel. As shown in FIG. 3A, the vehicle is in steady state and the normal components are accordingly balanced and approximately equal to one another. Additionally, the vehicle is accelerating in a first direction as shown by the arrows 151a, 151b, 151c, 151d. According to the embodiment of FIG. 3A, the vehicle includes an active suspension system that may be configured to independently adjust a normal component of a wheel force of each wheel. Additionally, the vehicle includes a rear steering system configured to apply steering force to rear wheels of the vehicle (e.g., third wheel 150c and fourth wheel 150d).

As shown in FIG. 3A, the road 200 includes a road feature 202. The road feature of FIG. 3A may be a road surface with lower friction relative to the nominal road surface. In the embodiment of FIG. 3A, the road feature 202 creates a split μ scenario, with different coefficients of friction between tires and the road surface on different sides of the vehicle (e.g., left and right sides of the vehicle). In the state illustrated in FIG. 3A, the vehicle is about to undergo braking at a braking start line 204. The road features begin at line 206. As discussed previously, reduced tire friction on one side of the vehicle may result in a yaw moment applied to the vehicle. This yaw moment may be compensated for via application of twist force and rear steering force, as discussed further with reference to FIGS. 3A-3C.

FIG. 3B is a schematic of the vehicle 100 and road of FIG. 3A in a second state. As shown in FIG. 3B, the vehicle has begun braking. First, load transfer shifts the normal load away from the rear wheels 150c, 150d, and to the front wheels 150a, 150d. As shown in FIG. 3B, the circles of the third wheel 150c and fourth wheel 150d are reduced relative to FIG. 3A, showing the difference in normal force. In FIG. 3B, the second wheel 150b has encountered the road feature 202. As discussed previously, the friction coefficient between the second wheel and the road 200 may be lower than first wheel 150a due to the road feature 202 (for example the road feature may be an ice patch). Accordingly, the braking applies a yaw moment 208 on the vehicle which urges the vehicle to turn left. In a conventional vehicle, this yaw moment may destabilize the vehicle, and a vehicle control system may reduce braking force to compensate. However, in the vehicle of FIG. 3B, an active suspension system may be controlled to compensate for the difference in braking force on the two sides of the vehicle, and a rear steering system may be configured to compensate for any remaining yaw moment 208, as shown in FIG. 3C.

As shown in FIG. 3C, the active suspension system may increase a normal component of a contact force for some of the vehicle wheels. In particular, the filled in circles shown in FIG. 3B denote wheels at which the active suspension applies a downward force to the wheels (e.g., increases a normal load on the wheel). Accordingly, as shown in FIG. 3C, the second wheel 150b and the third wheel 150c have their normal loads increased by the active suspensions (e.g., a twist force is applied to the vehicle). As the normal loads on the second wheel 150b and third wheel 150c are increased, the normal loads on the first wheel 150a and fourth wheel 150d are correspondingly decreased. As a result, the normal load on the second wheel 150b is greatest due to the combination of load transfer and twist force applied to the vehicle. The normal load on the second wheel 150b is greater than the normal load on the first wheel 150a. This difference in normal loads between the front wheels allows additional braking force to be generated at the second wheel 150b, reducing a yaw moment caused by the road feature 202. As shown in FIG. 3B, the normal load on the third wheel 150c is also greater than a normal load on the fourth wheel 150d.

In some embodiments, a vehicle 100 may apply the twist pattern shown in FIG. 3C when wheel slip is detected. For example, an ABS system may be activated during the braking event when the second wheel 150b encounters the road feature 202. Accordingly, the application of twist force may be reactive. In some embodiments, the vehicle may determine that one of the front wheels is slipping more than another (e.g., the second wheel 150a is slipping more than the first wheel 150a). Upon determining a disparity in the wheel slip on two sides of a vehicle, the twist force may be applied to the vehicle with the active suspension system. In some embodiments, the vehicle may determine an absolute value of wheel slip based on wheel torque, wheel speed, and vehicle speed for the wheels of the vehicle. If the wheel slip for one wheel exceeds a threshold, the twist force may be applied to increase a normal force load on that wheel.

In some embodiments, a vehicle 100 may apply the twist pattern shown in FIG. 3C at least partially based on reference road information and/or forward-looking road information (e.g., from a forward-looking sensor). For example, the vehicle 100 may predict the road features 202 based on a priory road information and control the braking system and active suspension system accordingly. In some such embodiments, the normal force load on the second wheel 150b and third wheel 150c may be adjusted prior to the first wheel reaching line 206. In this manner, the vehicle may prepare for road features to reduce their effect on the dynamics of the vehicle. In some embodiments, the reference road information or forward-looking road information may be employed to apply temporary increases in normal force load to a wheel without applying a twist force. For example, if the road feature 202 may have a feature size such that the suspension response may be applied over a duration of less than or equal to 1 second, the active suspension system may increase the normal force load of the single wheel or two wheels that encounter the feature. For example, the normal force load of the second wheel 150b may be increased without increasing the normal force load of the third wheel 150c. Such an arrangement may impart acceleration to a body of the vehicle 100, which may be detrimental if the road feature is larger in length. Accordingly, the reference road information and/or forward-looking road information may be employed to determine if a road feature size exceeds a road feature threshold so that the suspension of the vehicle may be appropriately controlled.

As shown in FIG. 3C, steering force may also be applied to the wheels 150a, 150b, 150c, 150d. In some cases, application of the twist force may not along be enough to eliminate a yaw moment on the vehicle (e.g., see FIG. 3B). That is, the longitudinal force shown by arrows 151a, 151c generated by the first wheel 150a and third wheel 150c, respectively, may be greater than the longitudinal force shown by arrows 151b, 151d generated by the second wheel 150b and the fourth wheel 150d. Accordingly, as shown in FIG. 3C, steering force may be applied to the wheels to counter the effects of the yaw moment. In particular, as shown in FIG. 3C, the third wheel 150c and the fourth wheel 150d (e.g., rear wheels of the vehicle) may be steered by a rear steering system in a direction opposite the yaw moment. In this manner, the rear wheels of the vehicle may apply a counter yaw moment to counteract the yaw moment generated by the longitudinal forces. In some embodiments, a vehicle may determine the yaw moment on the vehicle and control the active suspension system and rear steering system accordingly to cancel or otherwise mitigate the determined yaw moment. In some embodiments as shown in FIG. 3C, steering force may also be applied to the first wheel 150a and the second wheel 150b to counter the yaw moment. Therefore, two or more vehicle systems, such as for example, active suspension, braking, and rear steering systems, may cooperate to produce improved vehicle performance, e.g., improved braking and reduced stopping distance, while mitigating or eliminating certain undesirable side-effects that could otherwise result, such as for example, increased yaw moment.

In some embodiments, the steering force applied as shown in FIG. 3C may be the result of a user input (e.g., received at a user interface of the vehicle such as a steering wheel). In some embodiments, the vehicle may provide a cue to the driver to provide an appropriate input at the user interface to counter the effects of the road feature 202. For example, the vehicle may cue the driver to provide an appropriate steering and/or rear steering input to counter a yaw moment generated by the longitudinal force differences on the wheels. In some embodiments, the active suspension system may adjust the contact forces of the wheels based on the appropriate input cued to the user, with the expectation that the user will provide the appropriate input. In some embodiments, the vehicle may confirm the user is inputting the appropriate input before controlling another vehicle system based on the appropriate input. Such an arrangement may ensure vehicle systems are operated cooperatively and operation of a vehicle system does not conflict with user input.

In some embodiments, the active suspension force application described in FIG. 3A-C may be inverted. For example, the active suspension may increase the normal force on the front wheel experiencing higher friction (e.g., the first wheel 150a in FIGS. 3B-3C) to increase total braking force. This application of active suspension force may lead to an increased yaw disturbance imparted to the vehicle, but also to an increase in braking force on the front wheel that has the highest traction. In some embodiments, this strategy may be used in conjunction with a steering system by commanding an appropriate steering moment from the steering system 124 to mitigate any additional yaw disturbance. In some embodiments, a strategy, to balance the braking force on the two sides of the vehicle or to increase the braking force on one side, may be determined by a vehicle control system based on information from vehicle sensors and/or upcoming road information, for example information regarding the extent and magnitude of the road event and information regarding the criticality of the braking situation (for example, if the vehicle is about to impact another vehicle ahead of it, a strategy of maximizing braking at the expense of possible yaw disturbance may be employed, or for example, if the roadway is narrow but no obstacle is detected ahead a strategy of minimizing yaw disturbance may be employed).

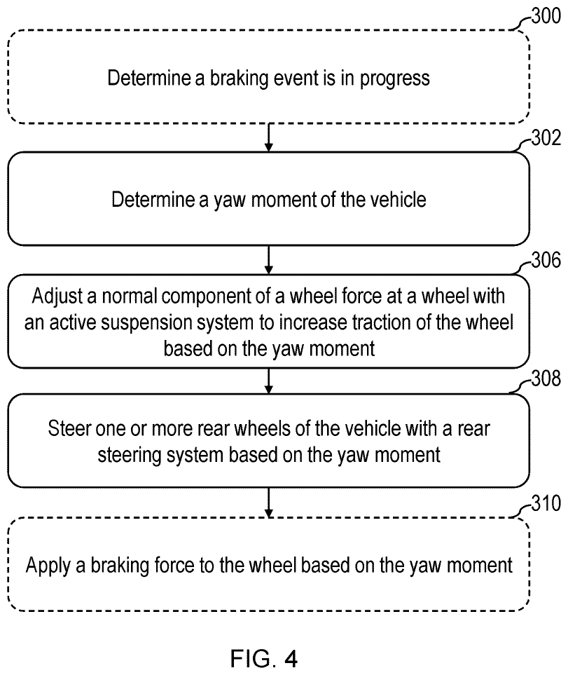

FIG. 4 is a flow chart for one embodiment of a method of controlling a vehicle. In optional block 300, it is determined a braking event is in progress. In some embodiments, presence of a braking event may initiate the method of FIG. 4. In some cases, braking events may corresponding to a circumstance in which it may be desirable to apply rear steering to compensate for any yaw moments generated as a result of the braking event. In block 302, a yaw moment of the vehicle is determined. The yaw moment may be determined based on input from an accelerometer, or other sensor, in some embodiments. In block 306, a normal component of wheel force is adjusted with an active suspension system (e.g., by applying active forces) to increase a traction of the wheel. In some embodiments, multiple wheel forces maybe adjusted with the active suspension system as described herein. The control of the active suspension system may be based at least partially on the yaw moment. In block 308, one or more rear wheels of the vehicle may be steered by a rear steering system based at least partially on the yaw moment. In some embodiments, the rear steering system may at least partially, or substantially, cancel or mitigate the yaw moment. In optional block 310, a braking force may be applied to one or more vehicle wheels based at least partially on the yaw moment.

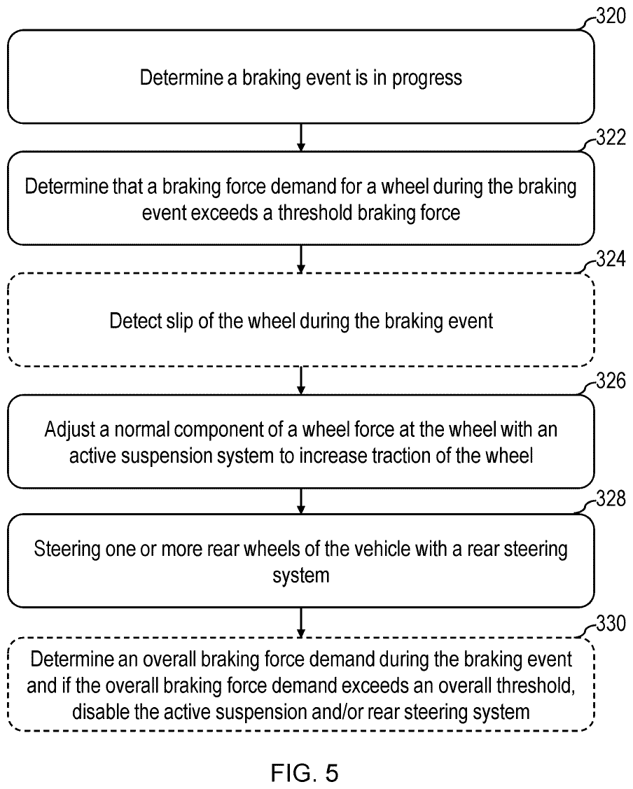

FIG. 5 is a flow chart for another embodiment of a method of controlling a vehicle. In block 320, it is determined that a braking event is in progress (e.g., via an input of a user at a brake pedal). In block 322, it is determined that the braking force demand for a wheel during the braking event exceeds a threshold braking force. For example, the braking force demand may exceed the traction of a wheel, triggering an anti-lock braking system. The threshold braking force may be aligned with a braking force that triggers the anti-lock braking system. In option block 324, wheel slip of the wheel may be detected during the braking event. The detection of wheel slip may correspond to a triggering of an anti-lock braking system. In block 326, a normal component of a wheel force at the wheel is adjusted (e.g., increased) with an active suspension system to increase the traction of the wheel. In block 328, one or more rear wheels of the vehicle are steered with a rear steering system. The steering of the one or more rear wheels may mitigate any yaw moment present on the vehicle during the braking event. In optional block 330, it is determined an overall braking force demand during the braking event and if the overall braking force demand exceeds an overall threshold, the active suspension and/or rear steering system may be disabled. Such a step may ensure that the braking system takes priority where slowing or stopping the vehicle is a priority, regardless of other vehicle dynamics such as a yaw moment.

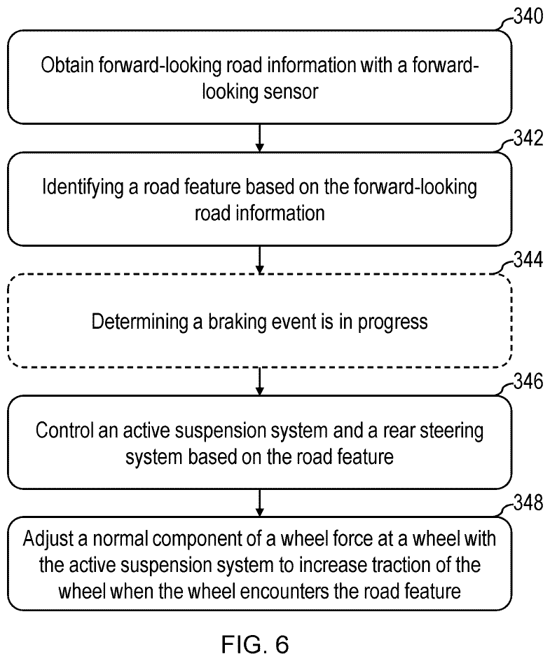

FIG. 6 is a flow chart for yet another embodiment of a method of controlling a vehicle. In block 340, forward-looking road information located ahead of a vehicles path of travel may be obtained with one or more forward-looking sensors (e.g., a camera, LIDAR, radar, etc.). In block 342, a road feature is identified based on the forward-looking road information. In optional block 344, it may be determined that a braking event is in progress. In some cases, if a braking event is not in progress the method may restart after block 344. In block 346, an active suspension system and a rear steering system may be controlled at least partially based on information related to the identified road feature. For example, the active suspension system and rear steering system may be prepared to, and subsequently operated, to at least partially compensate for the presence of the road feature proactively. In block 348, a normal component of a wheel force at a wheel with the active suspension system is adjusted to increase traction of the wheel when the wheel encounters the road feature. Such an arrangement may be beneficial if the road feature includes a lower coefficient of friction than a nominal road surface.

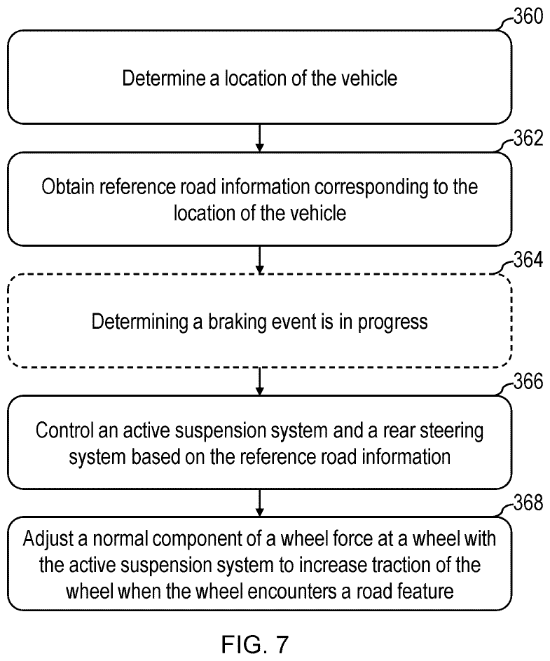

FIG. 7 is a flow chart for yet another embodiment of a method of controlling a vehicle. In block 360, a location of the vehicle is obtained (e.g., with GNSS, terrain-based localization, etc.). In block 362, reference road information is obtained corresponding to the location of the vehicle. In some embodiments, the reference road information may be downloaded from a server. In some embodiments, the reference road information may be stored on the vehicle and may be sourced from a prior traversal of a road associated with the location. In some embodiments, the reference road information may be acquired from a second vehicle ahead of the vehicle on the road. In optional block 364, it may be determined that a braking event is in progress. In some cases, if a braking event is not in progress the method may restart after block 364. In block 366, an active suspension system and a rear steering system may be controlled based at least partly on the reference road information, which may include information regarding one or more road features. For example, the active suspension system and rear steering system may be prepared, and subsequently operated, to at least partially compensate for the presence of the road feature proactively. In block 368, a normal component of a wheel force at a wheel with the active suspension system is adjusted to increase traction of the wheel when the wheel encounters a road feature. Such an arrangement may be beneficial if the road feature includes a lower coefficient of friction than a nominal road surface.

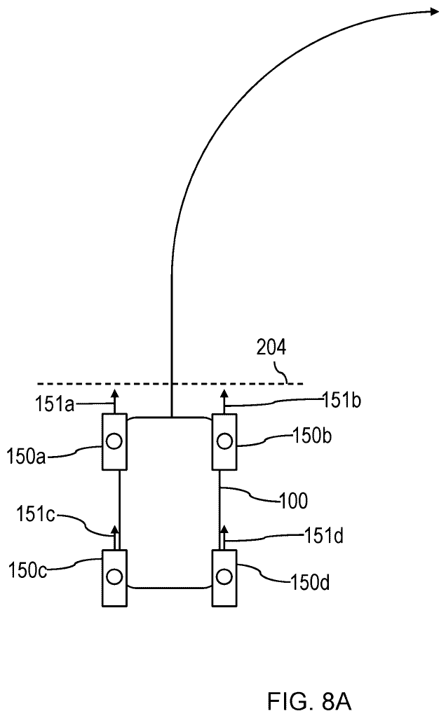

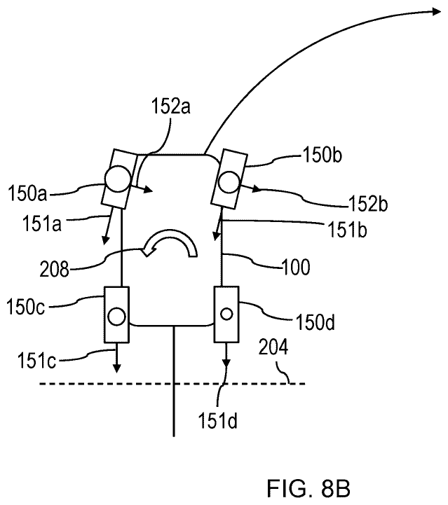

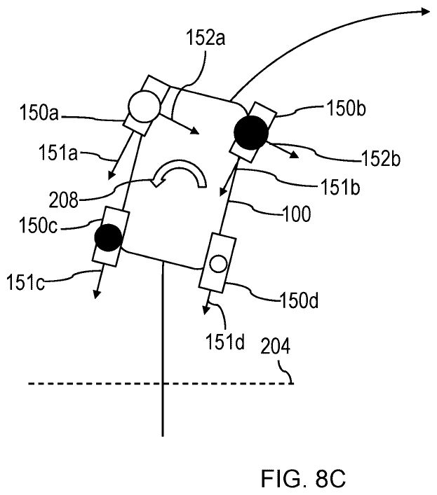

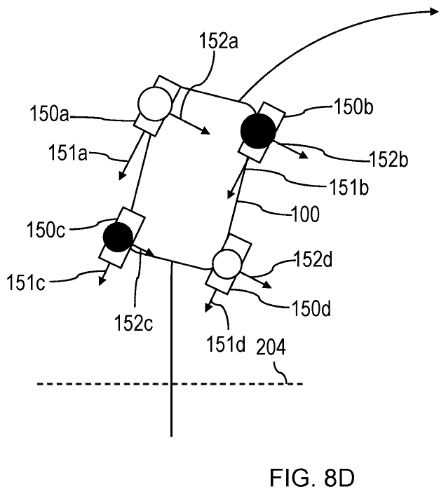

FIGS. 8A-8D depict a scenario with a vehicle 100 in a combination cornering and braking event. As shown in FIG. 8A, the vehicle 100 includes a first wheel 150a (e.g., front left wheel), a second wheel 150b (e.g., front right wheel), a third wheel 150c (e.g., rear left wheel), and a fourth wheel 150d (e.g., rear right wheel). The size of the circles disposed in the wheels shown in FIGS. 8A-8D corresponds to a normal component of a wheel force at a respective wheel. Each wheel also includes a longitudinal arrow 151a, 151b, 151c, 151d and a lateral arrow 152a, 152b, 152c, 152d that are representative of longitudinal forces and lateral forces on each of the wheels, respectively. As shown in FIG. 8A, the vehicle is in steady state and the normal components are accordingly balanced and approximately equal to one another. The vehicle includes an active suspension system that may be configured to independently adjust a normal component of a wheel force of each wheel. Additionally, the vehicle includes a steering system configured to apply steering force to each wheel (include rear wheels). As shown in FIG. 8A, the vehicle is in a first state prior to starting the braking and cornering event at line 204.

FIG. 8B is a schematic of the vehicle 100 of FIG. 8A in a second state after initiating the braking and cornering event. As shown in FIG. 8B, the application of braking force results in load transfer from the rear wheels 150c, 150d to the front wheels 150a, 150b, with a corresponding increase in normal force. Compared with FIG. 8A, the normal force loads of the first wheel 150a and second wheel 150b are greater, whereas the normal force loads of the third wheel 150c and fourth wheel 150d are reduced. In the state shown in FIG. 8B, the active suspension has not been activated. However, as shown in FIG. 8B, the vehicle has initiated a turn. In particular, the first wheel 150a and the second wheel 150b have been turned to generate a first lateral force shown by arrow 152a and a second lateral force shown by arrow 152b, respectively. Initiating the turn induces a roll acceleration on the vehicle which causes load transfer from one side of the vehicle to the other side of the vehicle. In particular, as shown in FIG. 8B, normal load is shifted from the right side of the vehicle to the left side of the vehicle. As a result, the first wheel 150a has a greater normal load than the second wheel 150b in the state of FIG. 8B Likewise, the third wheel 150c has an increased normal load compared with the fourth wheel 150d. As a result, a yaw moment 208 is induced on the vehicle which urges the vehicle out of the turn because of the disparity in normal force loads. A vehicle control system may detect this disparity and differences in wheel slip and adjust the normal force loads on the wheels with an active suspension system, as shown in FIG. 8C.

FIG. 8C is a schematic of the vehicle 100 of FIG. 8A in a third state. As shown in FIG. 8C, a twist force is applied to the vehicle. In particular, a normal load is increased at the second wheel 150b and the third wheel 150c, as shown by the filled in circles. As a result, normal force load is shifted away from the first wheel 150a and the fourth wheel 150d. According to the embodiment of FIG. 8C, the normal load on the first wheel 150a and the second wheel 150b is approximately equal. Accordingly, the yaw moment generated by braking differences between two front wheels may be reduced or eliminated. Additionally, the application of twist force may distribute the normal force load more evenly between the first wheel, second wheel, and third wheel, to allow the vehicle to stay in the intended path during the turn. Furthermore, as more normal load may be applied to the front wheels 150a, 150b overall, the overall braking force may be increased compared with a passive suspension system. In this manner, the adjustment of normal forces by an active suspension system may improve the performance of a vehicle in cornering and/or braking events. In some embodiments, a vehicle control system may determine that a braking force demand exceed a threshold braking force and may apply a twist force to the vehicle in response to ensure that a desired braking force is generated for a particular scenario.

Based on the state of FIG. 8C, a yaw moment 208 may not be entirely eliminated by the application of the twist force. For example, the combined longitudinal force shown by arrows 151a, 151c, from the first wheel 150a and the third wheel 150c may still exceed the combined longitudinal force shown by arrows 151b, 151d of the second wheel 150b and fourth wheel 150d. Accordingly, as shown in FIG. 8D, in some embodiment the vehicle may apply steering to one or more rear wheels (e.g., third wheel 150c and fourth wheel 150d) to at least partially, and in some instances substantially, mitigate or compensate for the remaining yaw moment 208 shown in FIG. 8C. As shown in FIG. 8D, the application of rear steering provides a third lateral force shown by arrow 152c and a second lateral force shown by arrow 152d which compensate for the yaw moment. Coordinating the response of the active suspension with the response of the steering system (if an active steering system is present) and the braking system enhances the response of the vehicle while reducing the need for the driver to intervene and the perception of the driver of a critical situation. In some embodiments, this coordination may for example be achieved by sensing the longitudinal and lateral acceleration of the vehicle and creating a model of the desired behavior, for example, a bicycle model of the vehicle. A change in the desired speed, as signaled by the driver through an application of brake pedal pressure or a release of the throttle pedal or as communicated by a vehicle control unit in the case of an autonomous or assisted vehicle, is communicated to the braking system and a decision is made on the intervention of other systems. If other systems are present, allowed to intervene, and signal that they are ready to act, then a command can be constructed to reduce yaw moment, and is apportioned to the appropriate response systems. In some embodiments, an active suspension system may be commanded to apply a twist force, and a rear steering actuator may be commanded to steer in the direction leading out of the turn at the same time, and the request may be turned off once the vehicle has stabilized as determined by the master controller. For example, the commands may be based on the actual yaw rate experienced by the vehicle as compared to the intended yaw rate based on either a model of the vehicle with the actual driver inputs, or based on a trajectory plan or path plan from an autonomous or semi-autonomous system.

In some embodiments, the application of twist force in this scenario may be dependent on an observation of desired yaw motion of the vehicle. For example, if the vehicle is determined to be understeering too much (e.g., if the vehicle's yaw rate is determined to be lower than a desired yaw rate determined by the control system by at least a value equal to a threshold value), then the active suspension force may be applied as described in FIG. 8A-8D. For example, if the vehicle is determined to be oversteering too much (e.g. if the vehicle's yaw rate is determined to be greater than a desired yaw rate determined by the control system by at least a value equal to a threshold value) then the application of active suspension force may be inverted to increase the normal load on the first wheel 150a and the fourth wheel 150d, and decrease the normal load on the second wheel 150b and third wheel 150c. in some embodiments, this application of force may be dynamically altered to control the yaw response of the vehicle to match a desired response. In some embodiments, this desired response may be determined by a calculation in the vehicle control system, or it may be predetermined. In some embodiments, the application of force may be determined based on a determined appropriate input cued to a user of the vehicle.

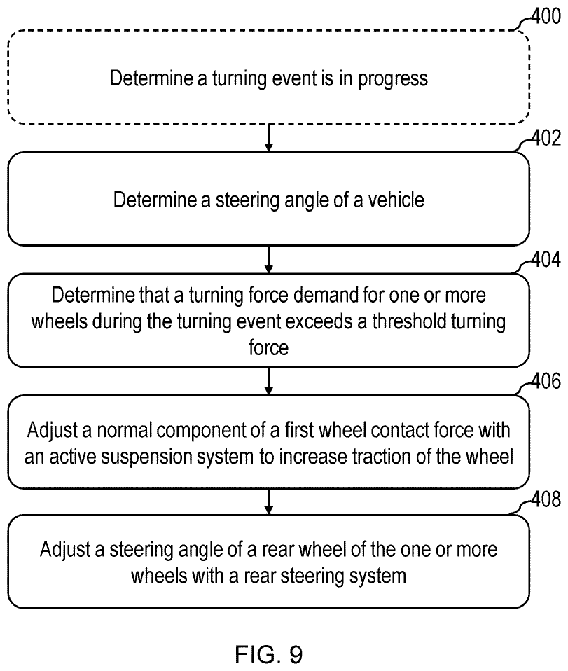

FIG. 9 is a flow chart for yet another embodiment of a method of controlling a vehicle. In optional block 400, it may be determined a turning event is in progress. For example, application of a steering torque by a user or other appropriate sensed input or vehicle response may signify a turning event. In another example, an autonomous system, such as an active steering system, may predict an upcoming turning event. In block 402, a steering angle of the vehicle is determined. In block 404, it is determined that a turning force demand for one or more wheels during the turning event exceeds a threshold turning force. In block 406, a normal component of a first wheel contact force is adjusted with an active suspension system to increase traction of the wheel as described above. In block 408, a steering angle of a rear wheel of the one or more wheels may also be adjusted with a rear steering system. The application of the rear steering may compensate for yaw moments on the vehicle that would otherwise introduce oversteer or understeer.

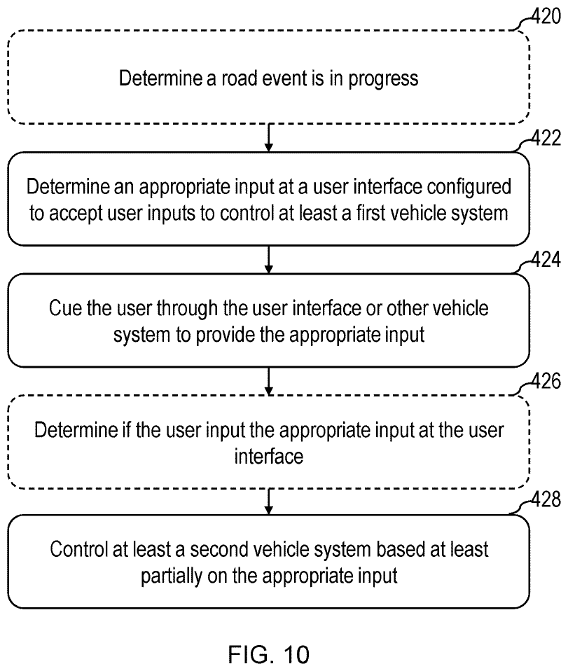

FIG. 10 is a flow chart for yet another embodiment of a method of controlling a vehicle. In optional block 420, it may be determined that a road event is in progress. In block 422, an appropriate input for controlling at least a first system of a vehicle may be determined for input at a user interface of the vehicle. The user interface may be configured to accept such an appropriate input from the user. In block 424, the user may be cued through the user interface, or another appropriate vehicle system, to provide the appropriate input. In some embodiments, the appropriate vehicle system may be a feedback system configured to provide feedback to the user. In some embodiments, the feedback system may include the user interface. For example, the user interface may be a steering wheel, which is configured to receive input from a user, and provide feedback to a user (e.g., by applying a steering torque). The vehicle may request a particular steering angle, steering torque, brake pedal force, etc. based on the one or more parameters associated with the road event. In optional block 426, it is determined if the user input the appropriate input at the user interface. For example, the vehicle may check that the user took the action requested or prompted by the cue. In some embodiments, the vehicle may check that the user is at least starting to take the action requested or prompted by the cue. For example, if the cue requests a change in steering angle, the method may include determining that the steering wheel is moving toward the cued steering angle. In block 428, in addition to the at least first vehicle system being controlled by the user input, at least a second vehicle system may be controlled based at least partially on the appropriate input. For example, an active suspension system may increase a normal load of a wheel contact force based on the cued steering angle, or other appropriate input, being applied. As a specific example, if the appropriate input is a steering angle (e.g., for a braking and turning event), the active suspension system may apply a twist force to the vehicle based on the expectation that the steering angle will be input by the user. In this manner, automated or semi-automated vehicle systems may be controlled in coordination with user input at the user interface. It should be noted that any vehicle systems described herein may be controlled in this manner in coordination with cued user input, according to any exemplary methods described herein.

The above-described embodiments of the technology described herein can be implemented in any of numerous ways. For example, the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A vehicle comprising:
a first wheel;
a second wheel;
a rear steering system configured to apply a steering force to one or more rear wheels of the vehicle;
an active suspension system operatively coupled to the first wheel and the second wheel, wherein the active suspension system is configured to apply active forces to the first wheel and the second wheel in at least one mode of operation to adjust a normal component of a first wheel contact force between the first wheel and a road surface and to adjust a normal component of a second wheel contact force between the second wheel and the road surface; and
at least one processor configured to control the rear steering system and the active suspension system, wherein the at least one processor is configured to:
determine a yaw moment of the vehicle; and
control the rear steering system and the active suspension system based at least partially on the yaw moment.

2. The vehicle of claim 1, further comprising a braking system configured to apply a braking force to the first wheel and the second wheel, wherein the at least one processor is configured to control the rear steering system, active suspension system, and braking system based at least partially on the yaw moment.

3. The vehicle of claim 2, wherein the at least one processor is configured to determine the yaw moment during a braking event.

4. The vehicle of claim 1, wherein the at least one processor is configured to:
determine a location of the vehicle,
obtain reference road information corresponding to the location of the vehicle, and
control the rear steering system and the active suspension system based at least partially on the reference road information.

5. The vehicle of claim 4, wherein the reference road information includes a road feature.

6. The vehicle of claim 5, wherein the road feature is a change in friction of the road surface relative to a nominal road friction.

7. The vehicle of claim 5, wherein the reference road information includes a curve on the road surface.

8. The vehicle of claim 1, wherein the first wheel is a front wheel of the vehicle, wherein the one or more rear wheels include the second wheel, and wherein the first wheel and the second wheel are positioned at opposite corners of the vehicle.

9. The vehicle of claim 8, wherein the at least one processor is configured to control the active suspension system to increase the normal component of the first wheel contact force and the normal component of the second wheel contact force based on the yaw moment.

10. The vehicle of claim 1, further comprising an active steering system, and wherein the at least one processor is configured to control the active steering system based at least partially on the yaw moment.

11. The vehicle of claim 1, wherein the at least one processor is configured to determine if the yaw moment exceeds a yaw moment threshold, and wherein the at least one processor is configured to control the active suspension system and the rear steering system based at least partially on the yaw moment upon determining the yaw moment exceeds the yaw moment threshold.

12. A method of controlling a vehicle including a rear steering system and an active suspension system, wherein the rear steering system is configured to apply a steering force to one or more rear wheels of the vehicle, and wherein the active suspension system is operatively coupled to a first wheel and a second wheel, the method comprising:
determining a yaw moment of the vehicle; and
controlling the rear steering system and the active suspension system based at least partially on the yaw moment, wherein controlling the active suspension system includes applying active forces to the first wheel and the second wheel to adjust a normal component of a first wheel contact force between the first wheel and a road surface and to adjust a normal component of a second wheel contact force between the second wheel and the road surface.

13. The method of claim 12, further comprising controlling a braking system configured to apply a braking force to the first wheel and the second wheel based at least partially on the yaw moment.

14. The method of claim 13, wherein determining the yaw moment occurs during a braking event.

15. The method of claim 12, further comprising:
determining a location of the vehicle;
obtaining reference road information corresponding to the location of the vehicle; and
controlling the rear steering system and the active suspension system based at least partially on the reference road information.

16. The method of claim 15, wherein the reference road information includes a road feature.

17. The method of claim 16, wherein the road feature is a change in friction of the road surface relative to a nominal road friction.

18. The method of claim 16, wherein the reference road information includes a curve on the road surface.

19. The method of claim 12, wherein the first wheel is a front wheel of the vehicle, wherein the one or more rear wheels includes the second wheel, and wherein the first wheel and the second wheel are positioned at opposite corners of the vehicle.

20. The method of claim 19, wherein controlling the active suspension system includes increasing the normal component of the first wheel contact force and the normal component of the second wheel contact force based on the yaw moment.

21-48. (canceled)
